(19) United States
(12) Patent Application Publication
(10) Pub. No.: US 2013/0059470 A1
(43) Pub. Date: Mar. 7, 2013

(54) ELECTRICAL CONNECTOR FOR TRANSMITTING ELECTRICAL POWER

(71) Applicant: ZHI-QIANG CHEN, Kunshan (CN)

(72) Inventor: ZHI-QIANG CHEN, Kunshan (CN)

(73) Assignee: HON HAI PRECISION INDUSTRY CO., LTD., New Taipei (TW)

(21) Appl. No.: 13/568,050

(22) Filed: Aug. 6, 2012

(30) Foreign Application Priority Data
Sep. 5, 2011 (CN) 201120329823.0

(51) Int. Cl. H01R 13/40; H01R 13/648

(52) U.S. Cl. 439/607.05; 439/658

(57) ABSTRACT

An electrical connector includes an insulative housing, a first terminal and a second terminal both disposed in the insulative housing. The insulative housing defines a receiving passageway for fixing the terminals and an inserted channel through with the receiving passageway. Each of the first terminal or the second terminal has a base portion located in the receiving passageway, a contacting portion extending into the inserted channel and a tail extending out of the insulative housing. The first terminal further has a encircling portion at an end of the tail of the first terminal. At least, a portion of the tail of the second terminal located in the encircling portion so as that the tail of the second terminal may be held by the tail of the first terminal. Therefore the tails of the two terminals are immovable respectively.

### BACKGROUND OF THE INVENTION

1. Field of the Invention

The present invention relates to an electrical connector, and more particularly to an electrical connector for transmitting electrical power.

2. Description of the Related Art

Taiwan Patent Issued Number M365572 issued on Sep. 21, 2009 discloses an electrical connector for transmitting electrical power. The electrical connector includes an insulative housing and a plurality of conductive terminals inserted in the insulative housing. Every two adjacent terminals form a pair and math a terminal of a mating connector. The soldering tails of each pair of terminals are paralleling to each other for soldering on a same conductive pad of a print circuit board on which the connector is mounted. However, there is no mutual engagement between every two juxtaposed soldering tails so that it's easy to separate, which lead to welding difficulty or poor signal transmission. Obviously, an improved electrical connector which can solve the problem is needed.

### SUMMARY OF THE INVENTION

Accordingly, an object of the present invention is to provide an electrical connector with a good performance of welding.

In order to achieve the object set forth, an electrical connector includes an insulative housing, a first terminal and a second terminal both disposed in the insulative housing. The insulative housing defines a receive passageway for fixing the terminals and an inserted channel through with the receive passageway. Each of the first terminal or the second terminal has a base portion located in the receive passageway, a contacting portion extending into the inserted channel and a tail extending out of the insulative housing. The first terminal further has a encircling portion at an end of the tail of the first terminal. At least, a portion of the tail of the second terminal located in the encircling portion.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is a perspective view of an electrical connector in accordance with the present invention;

FIG. 2 is another perspective view of the electrical connector;

FIG. 3 is an exploded perspective view of the electrical connector;

FIG. 4 is a cross sectional show of the electrical connector taken along line 4-4 in FIG. 1;

FIG. 5 is a perspective view of a first terminal and a second terminal shown in FIG. 2;

FIG. 6 is a perspective view of the two terminals shown in FIG. 5 engaged with each other;

FIG. 7 is a perspective view of a first terminal and a second terminal in accordance with another invention; and

FIG. 8 is a perspective view of the two terminals shown in FIG. 7 engaged with each other.

### DETAILED DESCRIPTION OF THE INVENTION

Reference will now be made to the drawing figures to describe preferred embodiments of the present invention in detail.

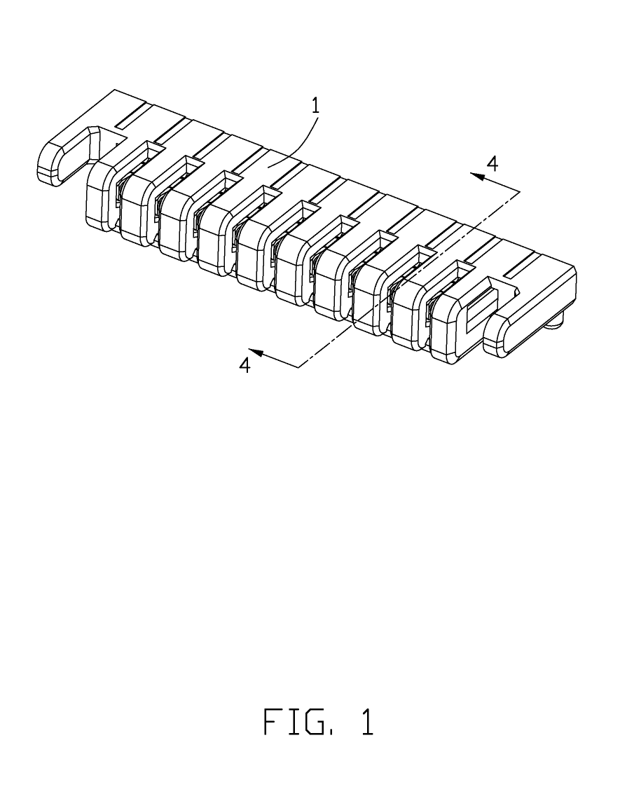

Referring to FIG. 1 to FIG. 3, an electrical connector in accordance with the present invention is provided and comprises a longitudinal insulative housing 1 and a plurality of terminals 2 disposed in the insulative housing 1.

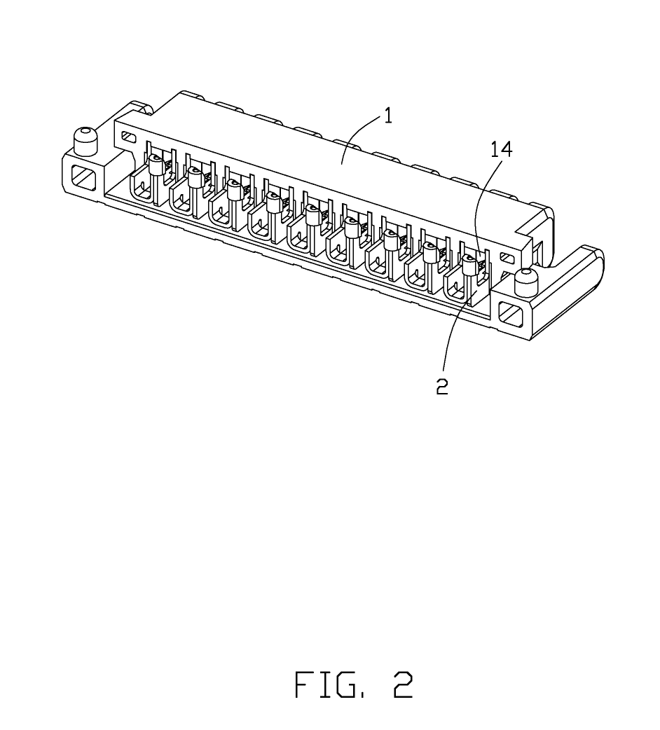

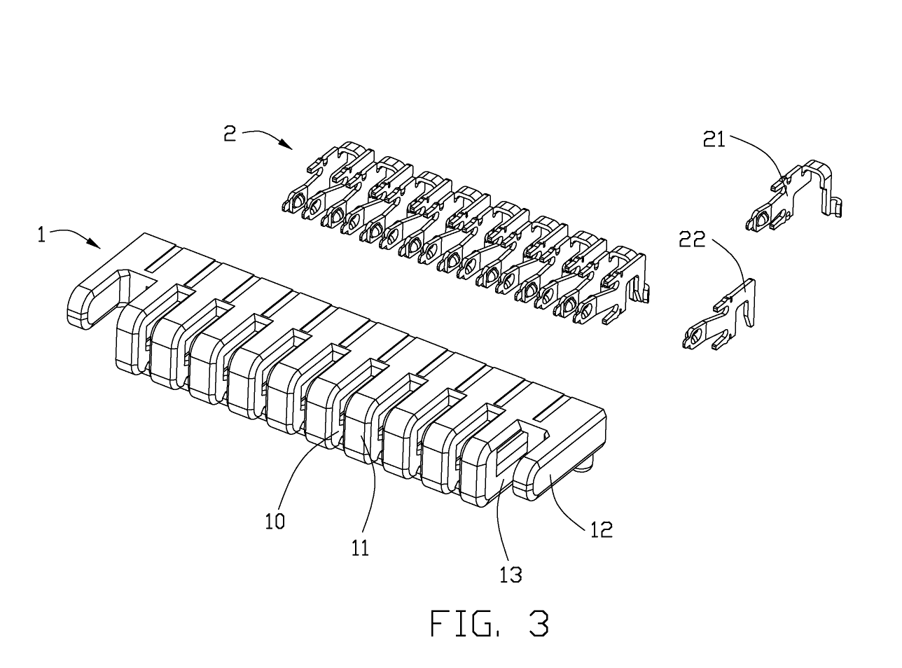

Referring to FIG. 2 and FIG. 3, the insulative housing 1 defines a plurality of inserted channels 10 running through three sidefaces of a front section of the insulative housing 1 which are separated by adjacent ribs 11. The insulative housing 1 further defines two sidewalls 12 shorter than the ribs 11 at the opposite longitudinal ends respectively which are separated from the adjacent ribs, thereby forming a guidance channel 13 to guide a mating connector. The insulative housing 1 defines a plurality of receives passageways 14 along the lateral sides of the ribs 11, which extends forwardly and communicates with the inserted channels 10 to receive the terminals.

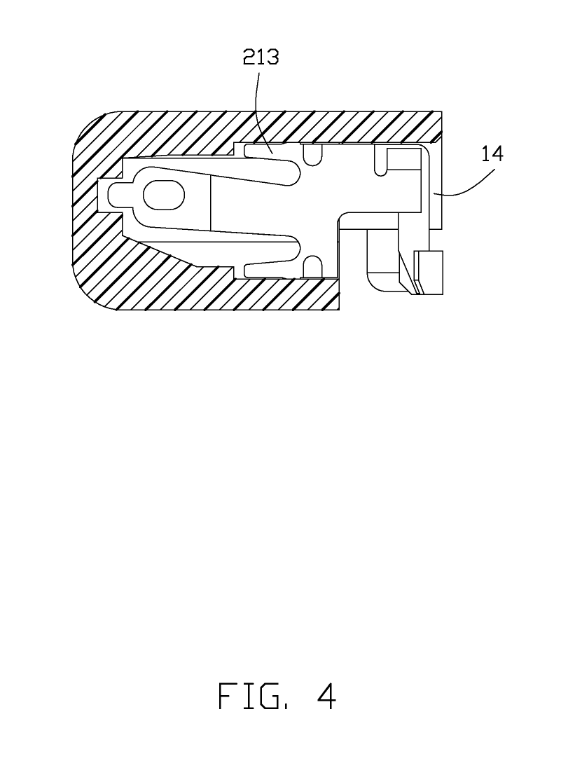

Referring to FIG. 3 to FIG. 6, the terminals 2 include a plurality of pairs of terminals, which include first terminals 21 and second terminals 22. The adjacent first terminal 21 and second terminal 22 receiving in receiving passageways opening to a same inserted channel 10 is configured as a pair of terminals to transmit one power. The first terminal 21 has a base portion 210 fixed in the receiving passageway 14, a contacting portion 211 extending forwards into the inserted channel 10 and a tail 212 rearwards extending out of the insulative housing 1. The base portion 210 defines two forwards retained portions 213 at both vertical sides thereof, respectively, so that the base portion 210 is retained in the housing. The second terminal 22 has a base portion 220 fixed in the receiving passageway 14, a contacting portion 221 extending into the inserted channel 10 and a tail 222 extending out of the insulative housing 1. The base portion 220 defines a connecting portion 223 at both vertical sides thereof, respectively. The connecting portions 213, 223 are used in conjunction with an interference of the insulative housing 1 in order to enhance the retention force of the terminal. The contacting portion 211 of the first terminal 21 defines a first tuber 214 projecting laterally and facing to the contacting portion 221 of the second terminal 22, and the contacting portion 221 of the second terminal 22 also defines a second tuber 224 projecting and facing to the contacting portion 211 of the first terminal 21. The first tuber 214 and second tuber 224 projecting to each other to increase the clamping force with the mating connector, to ensure a mating effect.

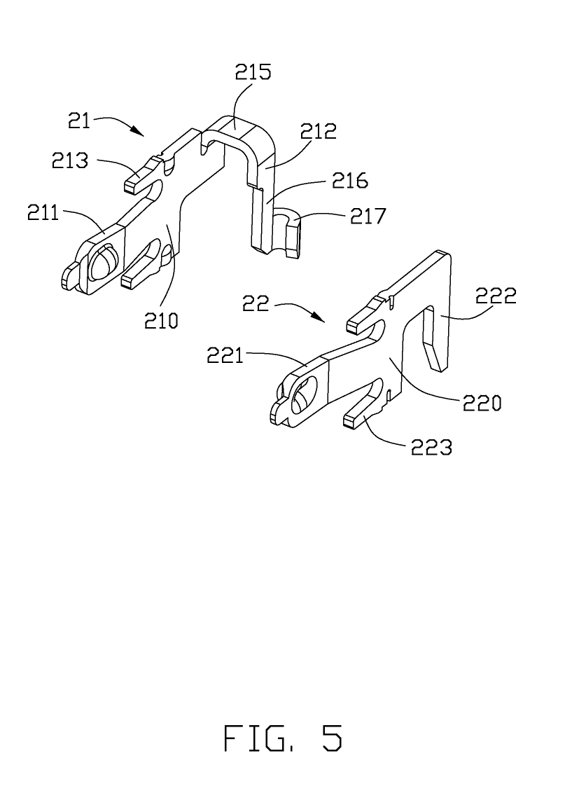

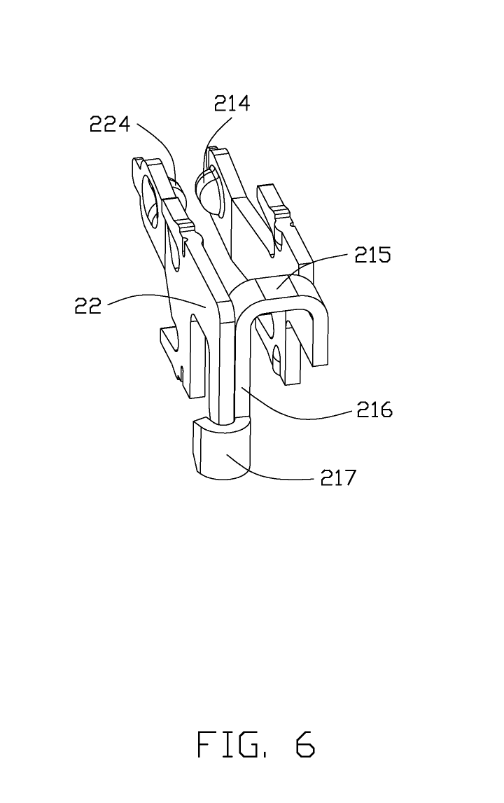

Referring to FIG. 5 to FIG. 6, the tail 212 of the first terminal 21 has a bestriding portion 215 laterally extending perpendicularly from the base portion 210, a connecting portion 216 extending perpendicularly from the bestriding portion 215 and an encircling portion 217 which is roughly U-shaped and has a free end at one side end thereof, extending from the connecting portion 216. When the first terminal 21 and the second terminal 22 of the pair of terminals are inserted in the receiving passageways 14 in the same inserted channel 10, the connecting portion 216 approach the facing side face of the tail 222 of the second terminal 22 and the encircling portion 217 surrounding the tail from a back side of the tail 222 because of the bestriding portion 215. The tail 222 of the second terminal 22 is located in the U-shaped encircling portion 217, so that the tail 222 of the second terminal 22 is better engaged with the connecting portion 216 since both sides of the tail 222 are limited against the encircling portion 217 and do not swing, by that the tails of the two terminals can be better fixed and not easy to separate, which is convenient that the two tails solder on a same conductive pad of a print circuit board.

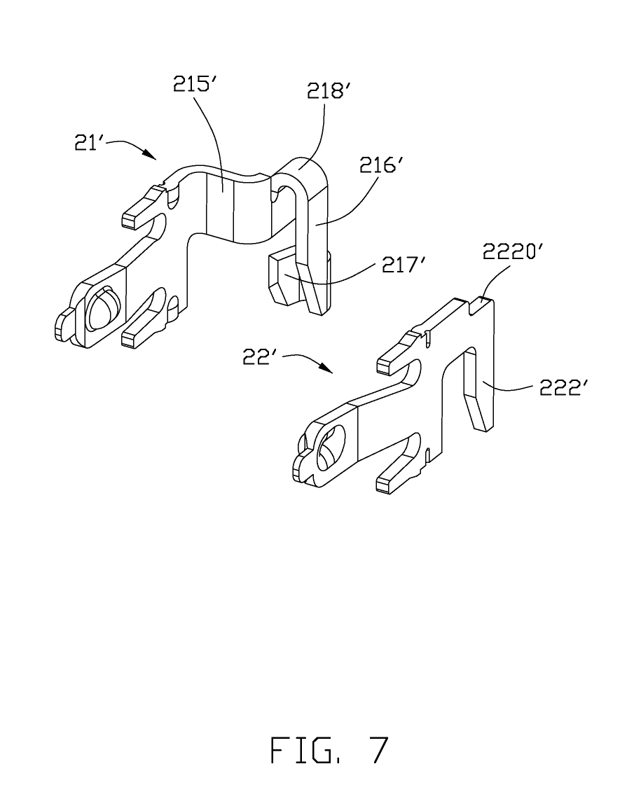

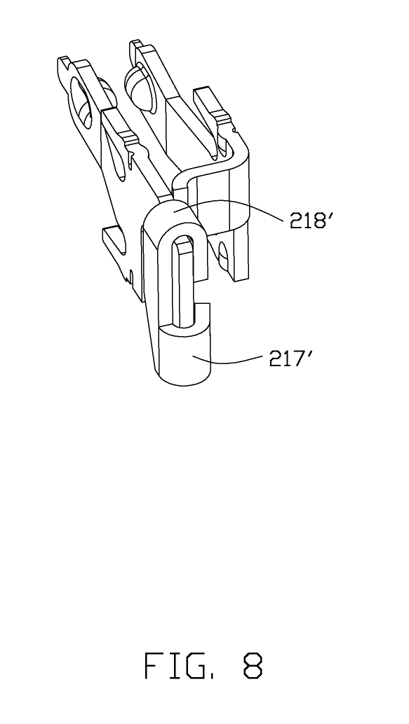

Referring to FIG. 7 to FIG. 8, which shows a contact pair of an alternative embodiment. Compared with aforementioned embodiment, there are something differences between the tails of the first terminal 21′ and the second terminal 22′. Detailed description of the contacts arrangement of the alternative embodiment is shown as below, and other similar elements and their relations between the two embodiments is omitted hereby.

The tail of the first terminal 21′ has a bestriding portion 215′, a shield portion 218′ extending from the bestriding portion 215′, a connecting portion 216′ extending from the bestriding portion 215′ and an encircling portion 217′, which is roughly U-shaped and has a free end at one side end thereof, extending from the connecting portion 216′. The tail 222′ of the second terminal 22′ defines a recess 2220′ at the top side thereof. The shield portion 218′ of U-shaped rides in the recess 2220′ so that the connecting portion 216′ is disposed at an outside of the tail 222′. The free end of the tail 222′ of the second terminal 22′ is located in the encircling portion 217′ so that the 222′ of the second terminal 22′ may be held by the first terminal 21′. Therefore the tails of the two terminals have a more stable combination.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector, comprising:
a plurality of first terminals and second terminals, the first terminals and the second terminals comprising base portions, contacting portions and tails;
an insulative housing defining a plurality of inserted channels and two receiving passageways communicating with each inserted channel and receiving one first terminal and one second terminal respectively, the contacting portions of said one first and said one second terminals projecting in the inserted channels;
wherein said one first terminal defines an encircling portion extending from the tail thereof and the encircling portion of said one first terminal fitly surrounding the tail of said one second terminal;

2. The electrical connector as described in claim 1, wherein the tail of said one terminal is disposed against the tail of said one second terminal.

3. The electrical connector as described in claim 2, wherein the encircling portion of said one first terminal is of a U-shape and surrounds a free end of said one second terminal.

4. The electrical connector as described in claim 3, wherein the tail of said one first terminal further has a bestriding portion extending laterally to said one second terminal and a connecting portion from which the encircling portion extends extending from the bestriding portion and juxtaposed the tail of said one second terminal.

5. The electrical connector as described in claim 4, wherein the connecting portion of said one first terminal extends parallelly to the tail of said one second terminal.

6. The electrical connector as described in claim 3, wherein the tail of said one first terminal further has a shield portion riding on said one second terminal.

7. The electrical connector as described in claim 6, wherein the tail of said one first terminal further has a bestriding portion extending laterally to said one second terminal and a connecting portion from which the encircling portion extends, the shield portion is located between the bestriding portion and the connecting portion.

8. The electrical connector as described in claim 1, wherein the contacting portion of said one first terminal defines a first tuber projecting laterally and facing to the contacting portion of said one second terminal, and the contacting portion of said one second terminal also defines a second tuber projecting and facing to the contacting portion of said one first terminal.

9. The electrical connector as described in claim 1, wherein each of the base portions of said one first terminal and said one second terminal defines a pair of retained portions at both sides thereof.

10. The electrical connector as described in claim 1, wherein the insulative housing has a pair of guidance channels at the opposite longitudinal ends thereof.

11. An electrical connector comprising:
an insulative housing defining a plurality of inserted channels,
a plural pairs of receiving passageways, each pair communicating with each inserted channel receiving passageway;
a plural pairs of terminals, each pair comprising a first terminal and a second terminal received respectively in the two corresponding receiving passageways, the first terminal and the second terminal comprising corresponding base portions retained in the housing, corresponding contacting portions projecting in the inserted channels, and corresponding tails; wherein
the first terminal defines an encircling portion extending from the tail thereof and fitly surrounding the tail of the second terminal.

12. An electrical connector for use with a complementary connector, comprising:
an insulative housing defining a plurality of ribs with an insertion channel formed between every adjacent two ribs for receiving a blade type contact of the complementary connector;
a plurality of contact sets disposed in the housing around the corresponding insertion channels, respectively, each of said contact sets defining a first terminal and a second terminal side each having a front contacting section for contacting the complementary connector, a rear tail section for mounting to another component, and a retention section therebetween for retaining said terminal to the housing; wherein
the contacting sections of the first terminal and the second terminal are distantly side by side located two sides of the corresponding insertion channel, respectively, for connecting to a same one blade type contact of the complementary connector, while the tail sections of the first terminal and the second terminal intimately side by side abuts against each other under condition that the tail section of one of said first terminal and said second terminal grasps the other to restrain horizontal relative movement therebetween.

13. The electrical connector as claimed in claim 12, wherein the tail section of one of said first terminal and said second terminal further grasps the other to restrain vertical relative movement therebetween.

14. The electrical connector as claimed in claim 13, where the tail grasping the other to prevent the horizontal relative movement and the tail grasping the other to prevent the vertical relative movement are the same one.

15. The electrical connector as claimed in claim 12, wherein the tail grasping the other around lowest ends of both said tail sections of said first terminal and said second terminal.

16. The electrical connector as claimed in claim 12, wherein the tail grasping the other essentially extends transversely toward the other while the tail which is grasped, extends essentially in a vertical plane without substantial transverse extension.

17. The electrical connector as claimed in claim 16, wherein the tail grasping the other extends transversely to the other initially in a horizontal plane and successively in a vertical plane.

18. The electrical connector as claimed in claim 16, wherein the tail grasping the other extends transversely to the other initially in a first vertical plane in a transverse direction, and successive in a second vertical plane in a front-to-back direction perpendicular to said transverse direction, and finally folded backward to form a U-shaped structure for grasping the other.

19. The electrical connector as claimed in claim 18, wherein said U-shaped structure prevents vertical relative movement between the two corresponding tail sections.

20. The electrical connector as claimed in claim 18, wherein said tail section grasping the other further defines another U-shaped structure to grasp the other, and one of said U-shaped structure restrains vertical relative movement while said another U-shaped structure restrains horizontal relative movement.
